(19) United States
(12) Patent Application Publication
(10) Pub. No.: US 2026/0100853 A1
(43) Pub. Date: Apr. 9, 2026

(54) VERIFIABLE CRYPTOGRAPHIC OBFUSCATION

(71) Applicant: Circle Internet Group, Inc., Boston, MA (US)

(72) Inventor: Vipin Singh Sehrawat, Fremont, CA (US)

(21) Appl. No.: 18/908,221

(22) Filed: Oct. 7, 2024

(51) Int. Cl. H04L 9/32; H04L 9/30

(52) U.S. Cl. CPC H04L 9/3278; H04L 9/30

(57) ABSTRACT

Methods, systems, and apparatus for verifiable cryptographic obfuscation. In one aspect, am obfuscator system receives an obfuscated program, a public seed and a secret seed, the public seed comprising a LPN encryption of a PRG input that is embedded in the obfuscated program, where the LPN encryption of the PRG input is generated using an error vector generated by physically unclonable function (PUF) included in the obfuscator system. The system computes a corrected PRG output obtained by evaluating the PRG on the LPN encryption of the PRG input using the public seed. The system predicts the error vector generated by the PUF and computes a corrupted PRG output obtained by evaluating the PRG on an LPN encryption of the PRG input and the predicted error vector. The system verifies the obfuscation of the program based on a Hamming distance between the corrected PRG output and the corrupted PRG output.

### TECHNICAL FIELD

This specification generally relates to methods, systems, and devices for cryptographic obfuscation.

### BACKGROUND

With increasing adoption and application space for blockchain, privacy-preserving smart contracts have emerged as an important field of study. In a world where smart contracts are ubiquitous, their internal state, data, and (proprietary) algorithms may need to be protected while ensuring that such protections do not hinder their usability.

There are some existing cryptographic solutions that can partially solve this challenge. For example, multiparty computation (MPC) can be used to allow a set of parties to access a private smart contract. However, the MPC setting is not meant to protect the function, i.e., the smart contract data, algorithms etc. Instead, its purpose is to protect the user's input to the smart contract. Furthermore, the set of parties authorized to use the smart contract must be limited and known beforehand for MPC. Finally, MPC solutions rely on assumptions, such as honest majority, which may not be guaranteed to hold in many distributed settings.

As another example, non-interactive zero knowledge proofs also do not fit perfectly in the target settings because they can only support limited types of smart contracts.

Non-cryptographic solutions for this problem are based on trusted execution environments (TEEs), which have been shown repeatedly as not an ideal standalone defense. If required, TEE-based solutions can be used as add-ons to sound cryptographic schemes, but relying only on the TEE is not a sound approach. To realize a world where users can seamlessly use smart contracts and blockchains without the need to know the proprietary algorithm and secret keys hardcoded in the smart contract, obfuscation is the ideal cryptographic candidate.

Program obfuscation aims to transform programs into functionally equivalent but otherwise opaque forms. That is, anyone can execute the obfuscated code and get correct results, but it is infeasible for them to learn the procedures and secrets embedded inside the code. It has been shown that indistinguishability obfuscation is the strongest feasible form of cryptographic obfuscation. Indistinguishability obfuscation requires that the obfuscations of any two circuits of same size and same functionality (namely, the same truth table) are computationally indistinguishable. Indistinguishability obfuscation, coupled with one-way functions, leads to almost all perceivable cryptographic primitives, including multiparty non-interactive key exchange, adaptively secure succinct garbled RAM, selectively sound and perfectly zero knowledge SNARKs, sender deniable encryption, fully deniable interactive encryption, constant round concurrent zero knowledge for all NP, multilinear maps with bounded poly degree, witness encryption for any NP language, secret sharing for all monotone functions, attribute based encryption for unbounded depth poly sized circuits, and fully homomorphic encryption with unbounded depth poly sized circuit-many of these cannot be realized in the absence of indistinguishability obfuscation.

### SUMMARY

This specification describes systems and methods for verifiable cryptographic obfuscation.

In general, innovative aspects of the subject matter described in this specification can include actions of receiving, from an obfuscator system, an obfuscated program, a public seed and a secret seed, the public seed comprising a learning with parity (LPN) encryption of a PRG input that is embedded in the obfuscated program, wherein the LPN encryption of the PRG input is generated using an error vector generated by physically unclonable function (PUF) included in the obfuscator system; computing, using the public seed, a corrected PRG output obtained by evaluating the PRG on the LPN encryption of the PRG input; predicting, using an initial component of the secret seed, the error vector generated by the PUF included in the obfuscator system; computing, using the public seed and the predicted error vector, a corrupted PRG output obtained by evaluating the PRG on an LPN encryption of the PRG input and the predicted error vector; computing a Hamming distance between the corrected PRG output and the corrupted PRG output; determining whether the Hamming distance is less than a predetermined threshold that is dependent on a length of the error vector; and in response to determining that the Hamming distance is less than the predetermined threshold, verifying the obfuscation of the program. Other implementations of this aspect include corresponding systems, apparatus, and computer programs, configured to perform the actions of the methods, encoded on computer storage devices.

These and other implementations can each optionally include one or more of the following features, alone or in combination: the initial component of the secret seed can include a tensor of a vector comprising an LPN secret vector used to generate the LPN encryption of the PRG input, wherein the tensor is of degree

$$⌈ \frac{d}{2} ⌉ ,$$

d representing a depth of the PRG circuit. Predicting the error vector sampled from the PUF included in the obfuscator system can include inputting the initial component of the secret seed into a regression model, wherein the regression model is trained to predict responses generated by the PUF included in the obfuscator system on unseen inputs. The method can further comprise, prior to receiving the obfuscated program, public seed and secret seed: training the regression model, comprising: generating a set of random challenges; sending the set of random challenges to the obfuscator system, wherein the obfuscator system runs the set of random challenges multiple times using the PUF to obtain multiple responses to each challenge in the set of random challenges; receiving, from the obfuscator system, the multiple responses to each challenge in the set of random challenges; and training the regression model on training data comprising the set of random challenges and multiple responses to predict responses generated by the obfuscator PUF on an unseen input challenge. The method can further include receiving, from the obfuscator system, a parameter used by the obfuscator system to construct the set system, and wherein the method further comprises using the parameter to verify that the LPN encryption of the PRG input was sampled from the set system. The public seed can be generated by the obfuscator system using a set system constructed by the obfuscator system, wherein inner products of pairs of representative vectors of the set system are equal to zero. The LPN encryption of the PRG input can be generated using a ring of integers modulo a prime number that is less than or equal to a minimum prime number included in a factorization of a parameter selected and used by the obfuscator system to construct the set system, wherein the representative vectors of the set system are sampled modulo the parameter. The LPN encryption of the PRG input can further comprise a public matrix sampled from a subset of sets included in the set system, wherein the subset of sets contains supersets of a randomly selected set in the set system, wherein a plurality of representative vectors of sets included in the subset of sets form columns of the public matrix. The LPN encryption of the PRG input can further comprise a LPN secret vector that is equal to a representative vector of the randomly selected set in the set system. The method can further comprise selecting, by the obfuscator system, a value of a parameter and using the parameter to construct, by the obfuscator system, the set system; sampling, by the obfuscator system, the public matrix from the subset of sets included in the set system; computing, by the obfuscator system, the representative vector of the randomly selected set in the set system and setting an LPN secret vector as equal to the representative vector; computing, by the obfuscator system and using the LPN secret vector, the initial component of the secret seed; providing, by the obfuscator system, the secret seed as input to the PUF to obtain an output that represents the error vector; and encoding, by the obfuscator system, the public matrix, LPN secret vector, error vector, and PRG input as the LPN encryption of the PRG input. a size of the set system can be exponential in a predetermined security parameter; each set in the set system can be of a size that is equal to zero modulo a parameter that comprises multiple different prime divisors; sizes of pairs of sets included in the set system can be equal or proportional; a size of an intersection of a first set included in the set system and a second set included in the set system can be equal to zero modulo the parameter that comprises multiple different prime divisors if the first or second set is contained in the second or first set, respectively, else non-zero; the set system can have t-wise restricted intersections modulo the parameter that comprises multiple different prime divisors; each set in the set system can be either a subset of a first constant number of sets included in the set system and not a superset of any set included in the set system or is a superset of a second constant number of sets included in the set system and not a subset of any sets included in the set system; or a size of an intersection of a first set included in the set system and a different second set included in the set system can be equal to zero or one, modulo each prime power divisor included in the parameter. The first constant number can be equal to s^{l-1}, where s is a constant that satisfies

$$s \geq exp ( c \frac{{( log ℓ )}^{r}}{{( log log ℓ )}^{r - 1}} ) ,$$

r is a number of unique prime divisors in the multiple prime divisors, [symbol] represents LPN dimension, and l is an integer that is less than a minimum prime divisor of the multiple prime divisors, and the second constant number is equal to l. Verifying that the LPN encryption of the PRG input was sampled from the set system can comprise: for each unique prime divisor included in the parameter: computing the LPN encryption of the PRG input modulo a prime divisor included in the parameter; evaluating the PRG on the computed LPN encryption of the PRG input modulo the prime divisor included in the parameter to obtain a respective PRG output; and determining whether the respective PRG output is equal to a second corrupted PRG output obtained by evaluating the PRG on the LPN encryption of the PRG input; and in response to determining that each respective PRG output is equal to the second corrupted PRG output obtained by evaluating the PRG on the LPN encryption of the PRG input, verifying the obfuscation of the program. The PRG can be a Boolean PRG in complexity class NC⁰. The method can further comprise, prior to receiving the obfuscated program, public seed and the secret seed, sharing, with the obfuscator system, values of cryptographic parameters for the obfuscation of the program. Computing the corrected PRG output obtained by evaluating the PRG on the LPN encryption of the PRG input can include using components of the secret seed to recover the output obtained by evaluating the PRG on the PRG input.

In general, other innovative aspects of the subject matter described in this specification can include actions of receiving, from an obfuscator system, an obfuscated program and a public seed, the public seed comprising a learning with parity (LPN) encryption of a PRG input that is embedded in the obfuscated program, wherein the public seed is generated by the obfuscator system using a set system constructed by the obfuscator system, wherein inner products of pairs of representative vectors of the set system are equal to zero; receiving a parameter used by the obfuscator system to construct the set system; for each unique prime divisor included in the parameter: computing the LPN encryption of the PRG input modulo a factor of the prime divisor included in the parameter, evaluating the PRG on the computed LPN encryption of the PRG input modulo the factor of the prime divisor included in the parameter to obtain a respective PRG output, and determining whether the respective PRG output is equal to a second corrupted PRG output obtained by evaluating the PRG on the LPN encryption of the PRG input; and in response to determining that each respective PRG output is equal to the second corrupted PRG output obtained by evaluating the PRG on the LPN encryption of the PRG input, verifying the obfuscation of the program. Other implementations of this aspect include corresponding systems, apparatus, and computer programs, configured to perform the actions of the methods, encoded on computer storage devices.

Some implementations of the subject matter described herein may realize, in certain instances, one or more of the following advantages.

The presently described techniques enable indistinguishability obfuscation (iO) schemes to be verified, improving the security of the iO schemes since incorrect or malicious obfuscations can be detected. The verifiability validates the behavior of an obfuscator in terms of verifying that the obfuscator used pre-decided hardware and cryptographic parameter to generate an obfuscated program or circuit, even though the verifying party does not possess the secret key or any other secret information on the circuit being obfuscated.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example cryptographic obfuscation verification system.

FIG. 2 is a block diagram of the example cryptographic obfuscation verification system of FIG. 1 during an example setup process.

FIG. 3 is a block diagram of the example cryptographic obfuscation verification during a first example cryptographic obfuscation verification process.

FIG. 4 is a block diagram of the example cryptographic obfuscation verification during a second example cryptographic obfuscation verification process.

FIG. 5 is a flowchart of a first example process performed by verifier system for verifying an obfuscation of a program.

FIG. 6 is a flowchart of a second example process performed by a verifier system for verifying an obfuscation of a program.

FIG. 7 is a flowchart of an example process performed by an obfuscator system for obfuscating a program.

Like reference numbers and designations in the various drawings indicate like elements.

### DETAILED DESCRIPTION

This specification describes methods and systems for verifiable cryptographic obfuscation. In some examples, verifiable obfuscation is achieved by introducing determinism to seeded PRG constructions via hardware generated errors such that Hamming distances between two evaluations of the PRG on the same input are smaller than a predetermined threshold, the threshold being dependent on an LPN dimension used by the seeded PRG construction. Alternatively or in addition, verifiable obfuscation is achieved using special super-polynomial-sized set systems. Both techniques enable a verifier to verify the behavior of the party responsible for obfuscating the program or circuit.

In some implementations, actions include receiving, from an obfuscator system, an obfuscated program, a public seed and a secret seed, the public seed comprising a learning with parity (LPN) encryption of a PRG input that is embedded in the obfuscated program, wherein the LPN encryption of the PRG input is generated using an error vector generated by physically unclonable function (PUF) included in the obfuscator system; computing, using the public seed, a corrected PRG output obtained by evaluating the PRG on the LPN encryption of the PRG input; predicting, using an initial component of the secret seed, the error vector generated by the PUF included in the obfuscator system; computing, using the public seed and the predicted error vector, a corrupted PRG output obtained by evaluating the PRG on an LPN encryption of the PRG input and the predicted error vector; computing a Hamming distance between the corrected PRG output and the corrupted PRG output; determining whether the Hamming distance is less than a predetermined threshold that is dependent on a length of the error vector; and in response to determining that the Hamming distance is less than the predetermined threshold, verifying the obfuscation of the program.

In some implementations, actions include receiving, from an obfuscator system, an obfuscated program and a public seed, the public seed comprising a learning with parity (LPN) encryption of a PRG input that is embedded in the obfuscated program, wherein the public seed is generated by the obfuscator system using a set system constructed by the obfuscator system, wherein inner products of pairs of representative vectors of the set system are equal to zero; receiving a parameter used by the obfuscator system to construct the set system; for each unique prime divisor included in the parameter: computing the LPN encryption of the PRG input modulo a factor of the prime divisor included in the parameter, evaluating the PRG on the computed LPN encryption of the PRG input modulo the factor of the prime divisor included in the parameter to obtain a respective PRG output, and determining whether the respective PRG output is equal to a second corrupted PRG output obtained by evaluating the PRG on the LPN encryption of the PRG input; and in response to determining that each respective PRG output is equal to the second corrupted PRG output obtained by evaluating the PRG on the LPN encryption of the PRG input, verifying the obfuscation of the program.

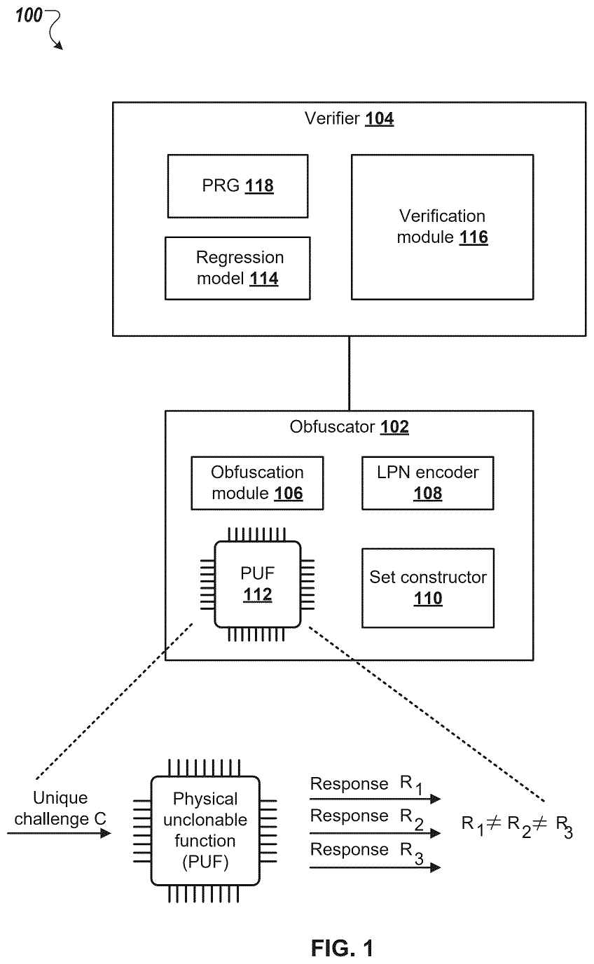

FIG. 1 is a block diagram of an example cryptographic obfuscation verification system 100. The example cryptographic obfuscation verification system 100 includes an obfuscator 102 and a verifier 104. The obfuscator 102 is a party that is responsible for obfuscating a circuit or program. The verifier 104 is a party that obtains an obfuscated circuit or program from the obfuscator 102 and verifies that the obfuscator 102 used specific hardware and predetermined secrets and parameters to obfuscate the circuit or program. The obfuscator 102 and verifier 104 can be connected over a network (e.g., a local area network (LAN), wide area network (WLAN), the Internet, or a combination thereof). The network can be accessed over a wired and/or a wireless communications link.

The obfuscator 102 is a computing system that can be implemented as one or more computer programs executed by one or more computers in one or more locations. The obfuscator 102 includes an obfuscation module 106, a learning parity with noise (LPN) encoder 108, a set constructor 110, and a physically unclonable function (PUF) 112. These computing components can be connected over a network (e.g., LAN, WLAN, the Internet, or a combination thereof), which can be accessed over a wired and/or a wireless communications link.

The obfuscation module 106 is configured to obfuscate a program or circuit. The obfuscation module 106 includes a PRG G. The PRG is a Boolean PRG in the complexity class NC⁰. The PRG is configured to evaluate input bitstrings σ ∈ {0,1}ⁿ and generate corresponding outputs G(σ) of length m=n^{1+∈}, where ∈>0. The PRG has a constant depth, has constant locality (each output bit depends only on a constant number of input bits), and can be written as a constant degree multivariate polynomial with integer coefficients. The obfuscation module 106 is configured to use the PRG to generate random values required to obfuscate a program or circuit, e.g., by evaluating the PRG on a public seed and a secret seed. The obfuscation module 106 is configured to embed the PRG and the public and secret seeds into an obfuscated program or circuit.

The LPN encoder 108 is configured to encode inputs to the PRG into learning parity with noise (LPN) instances. An LPN instance is defined as follows. For a security parameter λ, [symbol] =poly(λ) and n=poly( [symbol] ), given an LPN public matrix A of size [symbol] ×n, where elements of the LPN public matrix A are sampled uniformly from a ring of integers modulo a prime p and a LPN secret vector s of size [symbol] ×1, where elements of the LPN secret s are sampled uniformly from the same ring of integers modulo a prime p, and LPN instance is defined as As+e, where e represents a vector of length n with elements sampled from a Bernoulli distribution [symbol] _{τ} with bias τ over the ring of integers modulo a prime p. The so-called decision-LPN assumption states that the following two distributions are computationally indistinguishable for a PPT adversary: (A, sA+e) and (A, u) for u sampled uniformly from the ring of integers modulo a prime p. The bias is the probability with which an entry in e is nonzero and is therefore also called the error rate. No quantum or classical algorithm is known to efficiently solve LPN.

The LPN instances encoded by the LPN encoder 108 are used to form public seeds for the obfuscation of a program or circuit. In particular, the LPN encoder 108 is configured to generate public seeds as P=(A, sA+e+σ), where σ represents a PRG input. The components A, s of the LPN instances are generated using set systems constructed by the set constructor 110. The component s is, in turn, used to generate corresponding secret seeds as S=(S₀, S₁, . . . , Sₘ) where S₀=(1|s)^{⊗┌d/2┐}. This structure reduces the degree-d polynomial for the PRG G to a “degree 2.5” polynomial where the polynomial is degree-2 over the secret seed with coefficients that are deterministically generated from the secret seed S and the LPN instances included in the public seed P—for which the polynomial for G has a constant degree, i.e., 0(1) degree. It is noted that the LPN computations performed herein are performed modulo a prime p.

In some implementations, the obfuscator 102 is configured to generate error components e of the LPN instances using the PUF 112. The PUF 112 is a physical entity that is embodied in the physical structure of the obfuscator 102. For example, the PUF 112 can be implemented in an electrical circuit of the obfuscator 102. When a physical stimulus is applied to the PUF 112, the PUF 112 reacts due to the interaction of the stimulus with the physical microstructure of the device. The applied stimulus is called a challenge and the reaction of the PUF 112 is called a response. Contrary to standard digital systems, the PUF response depends on unavoidable nanoscale structural disorders in the hardware (e.g., introduced during manufacture), which lead to a response behavior that cannot be cloned or reproduced exactly, not even by the hardware manufacturer. That is, when a same unique challenge C is issued multiple times, the measured responses of the challenge R₁, R₂, R₃ differ with sufficient probability.

For meta-challenges, a same unique challenge issued to a strong PUF is guaranteed to be pseudorandom, i.e., unpredictable for a probabilistic polynomial time (PPT) adversary. However, for any unique highly-stable challenge, the output is the same with high probability. Hence, in the security model, while the PPT adversary is allowed to issue a polynomial (in terms of a chosen security parameter) number of queries, it is not allowed to issue the same query twice. This is because independence in the outputs for unique inputs is required, so that for unique inputs, a strong PUF remains indistinguishable (to a PPT adversary) from a random function. Therefore, the security game for PUFs is defined in a very similar manner to those used to establish the security of PRFs and PRGs—due to their deterministic nature. However, unlike PRFs and PRGs, PUFs are not fully deterministic—even for highly-stable challenges—which is why the term “with (very) high/low probability” is used when describing PUFs.

A specific challenge and a corresponding response form a so-called challenge-response pair (CRP). The error between a challenge and a response of the PUF 112 at an initial time and subsequent times (i.e., its variations in reproducibility) is referred to as a CRP error. A PUF can be classified as a weak PUF, if the PUF has a small number of challenge-response pairs or generates responses that are not independent but highly correlated. Conversely, a PUF can be classified as a strong PUF, if it has a large number of challenge-response pairs or generates responses that are largely independent or exhibit low correlation. Strong PUFs are sometimes preferred because they provide more entropy.

A PUF is called an implicit PUF, if it has unintended manufacturing variations as the sole source of its randomness. Conversely, a PUF is called an explicit PUF, if it uses external steps in addition to the manufacturing variations to generate randomness. In some implementations, the PUF 112 included in the classical verifier 104 is a strong, implicit PUF.

The usefulness of a PUF can be measured using two central metrics: reproducibility and uniqueness. Reproducibility is defined as δ=|d (PUFₜ_{₁}(x)−PUFₜ_{₂}(x))|, where |·| represents an absolute value, d (PUFₜ_{₁}(x)−PUFₜ_{₂}(x)) represents the Hamming weight between a PUF's output PUFₜ_{₁}(x) at time t₁ on input x and the PUF's output PUFₜ_{₂}(x) at time t₂ on the same input x. Smaller values of δ indicate larger reproducibility and vice-versa. The reproducibility δ of a PUF can be modeled as an independent Bernoulli or Gaussian distributed random variable. That is, PUFs can be used to generate both Bernoulli and Gaussian errors. Uniqueness is defined as Δ=|d(PUF₁(x)−PUF₂(x))|, where d(PUF₁(x)−PUF₂(x)) represents the Hamming distance between an output generated by a first PUF PUF₁ on input x and an output generated by a different, second PUF PUF₂ on the same input x. The value of Δ is directly proportional to the uniqueness of the pair of PUFs.

PUFs can run two types of challenges: highly-stable challenges and meta-stable challenges. Highly-stable challenges are challenges with responses that follow an almost static pseudorandom mapping. Hence, highly-stable challenges have low δ values and high reproducibility with standard error correction. Meta-stable challenges are challenges with responses that have a non-static distribution with 50% variation. Therefore, the responses to meta-stable challenges are random, giving them high δ value and low reproducibility. In some implementations, the PUF 112 included in the obfuscator 102 is configured to process challenges that include both highly-stable and meta-stable challenges.

The obfuscator 102 is configured to use the PUF 112 to process challenges (e.g., received from the verifier 104) and generate corresponding CRPs. The obfuscator 102 is further configured to use the PUF 112 to generate error vectors of elements sampled from a Bernoulli distribution and provide the error vectors to the LPN encoder 108.

The set constructor 110 is configured to construct specific set systems and vector families that enforce a verifiable structure to public seeds generated by the LPN encoder 108 and used by the obfuscation module 112 to obfuscate programs or circuits. Each set system (also referred to as a family of sets) is a non-uniform collection of sets defined over a common universal set of [symbol] elements, where the universal set is a set that contains all possible elements that can be members of the sets in the collection of sets. Each set system is constructed such that one or more of the following properties are satisfied.

First, the size (or cardinality) of the set system is larger than a predetermined threshold that is dependent on a predetermined parameter w (and its prime divisors). That is,

$$\vert ℋ \vert > exp ( c \frac{{l ( log ℓ )}^{r}}{{( log log ℓ )}^{r - 1}} ) + l exp ( c \frac{{( log ℓ )}^{r}}{{( log log ℓ )}^{r - 1}} ) ,$$

where c>0 is a constant, l≥2 is an integer such that l<min (p₁, . . . , pᵣ), where p₁, . . . , pᵣ are r different odd prime divisors of the parameter

$$w = {\prod }_{i = 1}^{r} {p}_{i}^{{α}_{i}} and {\{ {α}_{i} \}}_{i = 1}^{r}$$

are r<1 positive integers, and t≥2 and [symbol] lw are integers.

Second, each set included in the set system have a size that is equal to zero modulus the parameter w. That is, ∀H ∈ [symbol] : |H|=0 mod w.

Third, each pair of sets included in the set system have a same size, or sizes that are proportional with respect to the integer l. That is, ∀H₁, H₂ ∈ [symbol] , either |H₁|=|H₂|, |H₁=l|H₂| or l|H₁=|H₂|.

Fourth, for each pair of sets included in the set system such that the sets in the pair are different and one set is strictly contained in the other, the size of the intersection of the sets in the pair is equal to zero modulo w, otherwise the size of the intersection of the sets in the pair is not equal to zero modulo w. That is, ∀H₁, H₂ ∈ [symbol] , where H₁≠H₂: if H₂ ⊂H₁ or H₁ ⊂H₂, then |H₁ ∩H₂|≠0 mod w, else |H₁ ∩H₂|≠0 mod w.

Fifth, the set system has t-wise restricted intersections modulo w. That is, for integers w>15, t≥2 the set system [symbol] satisfies the following two conditions: a) ∀H ∈ [symbol] , |H|=0 mod w, and b) ∀t′ satisfying 2≤t′≤t, and ∀H₁, H₂, . . . , Hₜ, ∈ [symbol] with {H₁, H₂, . . . , Hₜ′} non-degenerate, it holds that:

$$\vert {⋂}_{τ = 1}^{{t}^{′}} {H}_{τ} \vert \neq 0 mod w .$$

Sixth, for

$$s \geq exp ( c \frac{{( log ℓ )}^{r}}{{( log log ℓ )}^{r - 1}} ) ,$$

one of the following two properties hold for all sets included in the set system: a) H ∈ [symbol] is a subset of exactly s^{l-1} sets and not a superset of any sets in [symbol] or b) H is a superset of exactly l sets and not a subset of any sets in [symbol] . Subsets that satisfy point a) are referred to herein as “subset only” subsets.

Seventh, for each pair of sets included in the set system, such that the sets in the pair are different, and for each product of a same prime divisor in a factorization of the parameter w, the size of the intersection of the sets included in the pair is either equal to zero or one modulus the product of the prime divisor. That is, ∀H₁, H₂ ∈ [symbol] , H₁≠H₂ and ∀i ∈ [r], it holds that either

$$\vert {H}_{1} ⋂ {H}_{2} \vert = 0 mod {p}_{i}^{{α}_{i}} or \vert {H}_{1} ⋂ {H}_{2} \vert = 1 mod {p}_{i}^{{α}_{i}} .$$

Each set in a set system constructed by the set constructor 110 can be represented by a unique vector of length [symbol] with entries taken from a ring of integers modulo w (referred to herein as representative vectors vᵢ ∈ [symbol] . These representative vectors can form a set-covering family of vectors. A set-covering family of vectors can be defined as follows. Let w, [symbol] >0 be positive integers, S ⊆ [symbol] \{0}, and W(·) and [symbol] ; [symbol] denote Hamming weight and inner product, respectively. It is said that a subset

$$𝒱 = {\{ {v}_{i} \}}_{i = 1}^{N}$$

of vectors in [symbol] forms an S-covering family of vectors if the following two conditions are satisfied: a) ∀i ∈ [N], it holds that: [symbol] vᵢ, vᵢ [symbol] =0 mod w, and b) ∀i, j ∈ [N], where i≠j, it holds that:

$$〈 {v}_{i} , {v}_{j} 〉 mod w = \{ \begin{matrix}0 & if W ( {v}_{i} ∘ {v}_{j} mod w ) = 0 mod w \\ ∈ S & otherwise\end{matrix} , \qquad ( 1 )$$

where • denotes Hadamard/Schur product.

Since w, l are positive integers such that

$$2 \leq l < min ( {p}_{1} , … , {p}_{r} ) , w = {\prod }_{i = 1}^{r} {p}_{i}^{{α}_{i}} has r > 1$$

different prime divisors: p₁, . . . , pᵣ, and the sizes of pairwise intersections of the sets in the set system occupy at most w−1 residue classes modulo w, then, the family of vectors formed by the representative vectors of all sets in the set system forms a set covering family for a set of size w−1 and an inner product of each pair of representative vectors in the family of vectors is equal to the size of the intersection of the corresponding sets in the set system modulo w. That is, if each set Hᵢ ∈ [symbol] is represented by a unique vector vᵢ ∈ [symbol] , then for a set S of size w−1, the family of vectors

$$𝒱 = {\{ {v}_{i} \}}_{i = 1}^{N}$$

formed by the Representative vectors of all sets in [symbol] , forms an S-covering family such that

$$N > exp ( c \frac{{l ( log ℓ )}^{r}}{{( log log ℓ )}^{r - 1}} ) + l exp ( c \frac{{( log ℓ )}^{r}}{{( log log ℓ )}^{r - 1}} )$$

and for all i, j ∈ [N], it holds that [symbol] vᵢ, vⱼ [symbol] =|Hᵢ∩Hⱼ| Mod w.

The verifier 104 is a computing system that can be implemented as one or more computer programs executed by one or more computers in one or more locations. The verifier 104 includes a regression model 114 and a verification module 116. In some implementations the verifier 104 includes a PRG 118. These computing components can be connected over a network (e.g., LAN, WLAN, the Internet, or a combination thereof), which can be accessed over a wired and/or a wireless communications link.

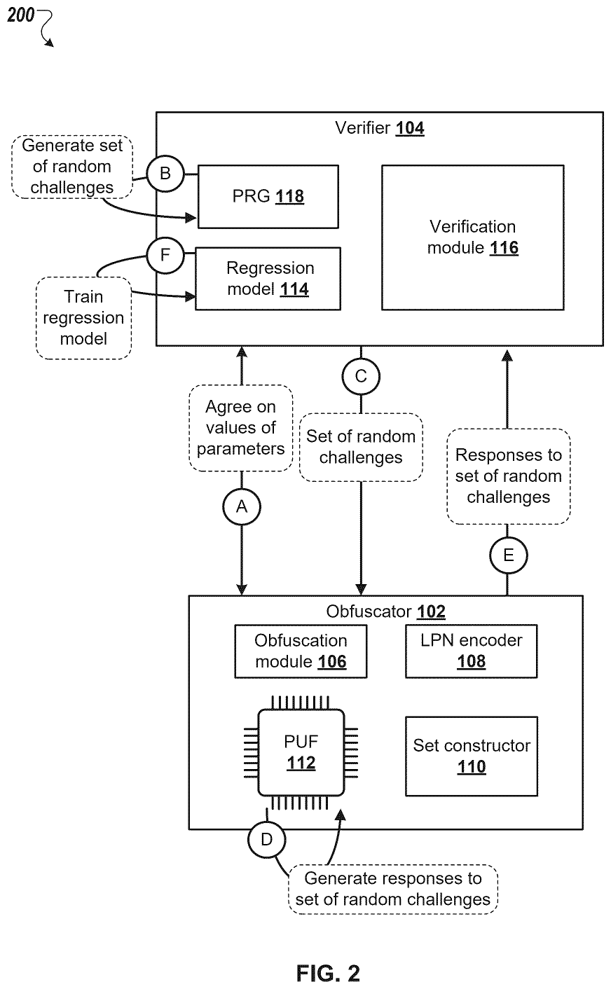

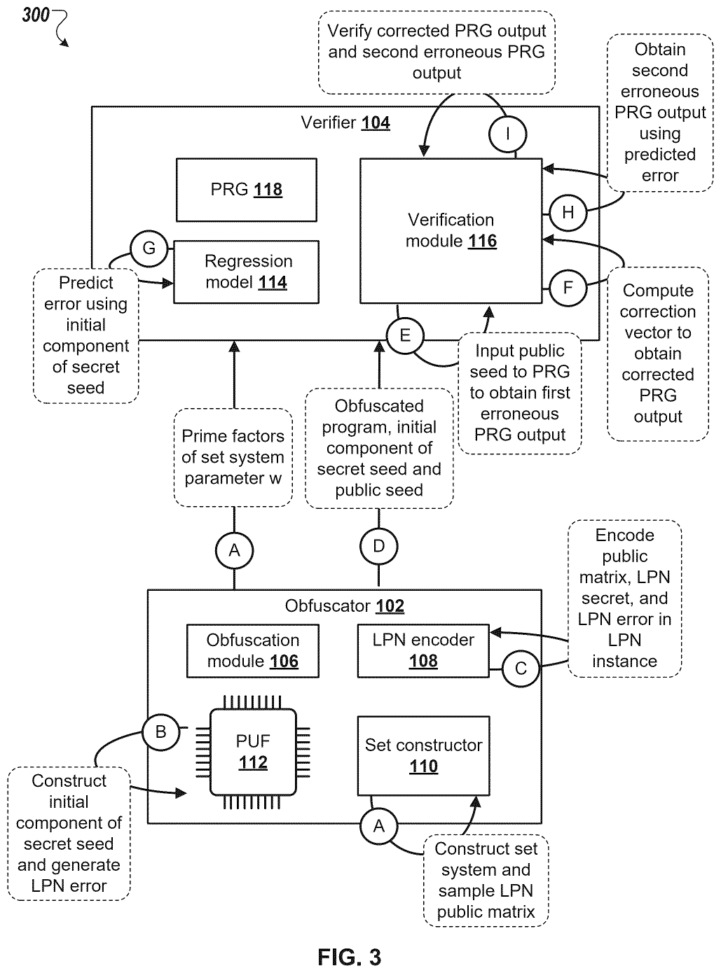

The regression model 114 is a machine learning model that is configured to predict challenge responses generated by the PUF 112. The verifier 104 is configured to train the regression model 114 to predict challenge responses generated by the PUF 112 using training data that includes challenge responses generated by the obfuscator 102, as described in more detail below with reference to FIG. 2. For example, the verifier 104 can train the regression model 114 to fit the training data as a linear function. The verifier 104 uses predictions generated by the regression model 114 to verify the behavior of the obfuscator in terms of it using predetermined hardware (e.g., the PUF 112) and cryptographic parameters. Example operations for training the regression model 114 and using the trained regression model 114 to verify the obfuscator are described in more detail below with reference to FIGS. 2 and 3.

The verification module 116 is configured to perform one or more verification processes to verify program obfuscations received from the obfuscator 102. That is, the verification module 116 is configured to verify that the obfuscator 102 used its PUF 112 (and correct values of pre-shared cryptographic parameters) to perform the obfuscation of the program (the verification module 116 is not configured to verify the program itself, since leaking information about the program is contrary to the definition of indistinguishability obfuscation). Example verification processes performed by the verification module 116 are described below with reference to FIGS. 3-6.

In some implementations the verifier 104 includes a PRG 118 (which is separate to the PRG used by the obfuscator 102 to obfuscate a circuit). The PRG 118 is a computer program that is configured to generate sequences of numbers with properties that approximate the properties of sequences of random numbers. The verifier 104 is configured to use the PRG 118 to generate sets of random challenges, e.g., as part of a setup process as described in more detail below with reference to FIG. 2.

FIG. 2 is a block diagram 200 of the example cryptographic obfuscation verification system 100 of FIG. 1 during an example setup process. The block diagram 200 illustrates the example setup process as including six stages (A)-(F). However, in some implementations, the example setup process can include fewer or more stages.

During stage (A) of the example setup process, the obfuscator 102 and verifier 104 share values of cryptographic parameters for the obfuscation and verification process. The cryptographic parameters include a security parameter A, which quantifies the security level of the cryptographic obfuscation. The parameters also include LPN dimensions [symbol] =poly(λ) and n=poly( [symbol] ), where [symbol] , n define the size of LPN public matrices, [symbol] defines the length of LPN secrets, and n defines the length of LPN error vectors used in the cryptographic obfuscation verification processes described herein. The parameters also include a prime number p, which defines a ring of integers modulo p from which, e.g., elements of the LPN error vectors are sampled from.

During stage (B) of the example setup process, the verifier 104 generates a set of random challenges. For example, the verifier 104 can use the PRG 118 to generate the set of random challenges. The set of random challenges includes [symbol] =poly(λ) challenges cᵢ(1≤i≤ [symbol] ), where each challenge is a binary valued vector of length m. In some examples the value m is bounded by a value that is polynomial in n.

During stage (C) of the example setup process, the verifier 104 sends the set of random challenges to the obfuscator 102. During stage (D), the obfuscator 102 uses its PUF 112 to run the set of random challenges received from the verifier 104. For example, the obfuscator 102 can run the set of random challenges multiple times, e.g., N>1 times, to generate N responses

$$P U {F}_{𝒪}^{( 1 )} ( {c}_{i} ) , P U {F}_{𝒪}^{( 2 )} ( {c}_{i} ) , … {PUF}_{𝒪}^{( N )} ( {c}_{i} )$$

for each random challenge cᵢ.

During stage (E) of the example setup process, the obfuscator 102 sends the responses to the random challenges to the verifier 104. During stage (F), the verifier 104 stores the responses as training data in the training data store 112. The verifier 104 uses the training data to train the regression model 114 to predict responses generated by the obfuscator on new, unseen input challenges (e.g., by fitting the responses received during stage (E) as a linear function). It can be shown that with sufficient number of queries, the regression model 114 can be used to predict the PUF's 112 response with 90-99% accuracy.

FIG. 3 is a block diagram 300 of the example cryptographic obfuscation verification 100 of FIG. 1 during a first example cryptographic obfuscation verification process. The cryptographic obfuscation verification system 100 can perform the first example cryptographic obfuscation verification process after the setup process described above with reference to FIG. 2. The block diagram 300 illustrates the first example cryptographic obfuscation verification process as including nine stages (A)-(I). However, in some implementations the first example cryptographic obfuscation verification process can include fewer or more stages.

During stage (A) of the first example cryptographic obfuscation verification process, the obfuscator 102 uses the set constructor 110 to construct a set system. The set system is constructed such that the set system satisfies the properties described above with reference to FIG. 1. In addition, the set system is constructed such that that the size of the set system, i.e., the number of sets in the set system is larger than 2^{λ}, where λ is the security parameter defined in the setup process described with reference to FIG. 2. Since the size of the set system is, by construction, super-polynomial in a modulus w, the size of the set system is dependent on the number and size of the primes factors of w. Therefore, a large set system can be realized even with small values of the security parameter λ. During stage (A), the obfuscator 102 does not provide or leak specific parameters about the construction of the set system to any parties except for the verifier 104, who is provided with the prime factors of w.

Further, during stage (A), the obfuscator 102 also samples an LPN public matrix according to the LPN dimension parameters defined in the setup process from the constructed set system. The obfuscator 102 randomly selects a subset from the set system. The subset can be a “subset only” subset, as described with reference to property 6a) in the description of FIG. 1. The obfuscator 102 then identifies a subset of the sets in the set system that includes supersets of the randomly selected subset. That is, the obfuscator 102 selects a “subset only” type subset H ∈ [symbol] , then identifies a subset [symbol] _{H} of the sets in the set system [symbol] that contains supersets of the “subset only” type subset H. The obfuscator 102 then samples n sets from the subset [symbol] _{H} (where the value of n was determined during the setup process).

The obfuscator 102 uses the n sets to construct the LPN public matrix. In particular, the LPN public matrix is constructed from representative vectors of the n sets, i.e., representative vectors from the covering vectors family for the selected subset [symbol] _{H} with cardinality n. The obfuscator 102 also sets an LPN secret as equal to the representative vector for the subset only” type subset H. Therefore, by construction, for all i ∈ [r] and j ∈ [n], it holds that:

$$〈 {a}_{j} , s 〉 = 0 mod {p}_{i}^{{α}_{i}} and sA = 0 mod {p}_{i}^{{α}_{i}} \qquad ( 2 )$$

where aⱼ is a j-th representative vector and forms a j-th column of the public matrix A, s represents the LPN secret, and

$${p}_{i}^{{α}_{i}}$$

is a factor of the parameter w. This means that anyone with the knowledge of the factorization of the parameter w can correctly verify the structured public portion of the seed.

Since the randomly selected subset is of the “subset only” type, the cardinality of the subset [symbol] _{H}, containing its supersets is

$${s}^{l - 1} for s \geq exp ( c \frac{{( log ℓ )}^{r}}{{( log log ℓ )}^{r - 1}} ) .$$

Therefore, when compared to the ring [symbol] _{w}, sampling the LPN public matrix from [symbol] _{H} does not (significantly) reduce the sample space and entropy. Sampling from [symbol] _{H} therefore does not weaken the security of LPN (or LWE).

During stage (B), the obfuscator 102 uses the LPN secret s determined during stage (A) to compute an initial component of a PRG secret seed. The initial component of the PRG secret seed is a non-decomposable tensor given by

$${S}_{0} = {( 1 ‖ s )}^{⊗ ⌈ d / 2 ⌉} \qquad ( 3 )$$

where 1∥s represents a concatenation of the bit “1” with the LPN secret s and d represents the depth of the PRG circuit. The obfuscator then provides the initial component of the PRG secret seed as input to its PUF 112 to obtain an LPN error e=PUF(S₀).

During stage (C), the obfuscator 102 encrypts an input σ to the PRG in an LPN instance as As+e+σ, where A represents the LPN public matrix, s represents the LPN secret, and e represents the LPN error. The LPN public matrix and LPN encryption of the input ∝ forms a public seed

$$P = ( A , A s + e + σ ) \qquad ( 4 )$$

### for the PRG.

During stage (D), the obfuscator 102 obfuscates a program using the PRG, the public seed P, and the secret seed S. The obfuscator 102 sends the obfuscated program (which includes the PRG, e.g., as part of its codebase), the secret seed S, and the public seed P to the verifier 104.

During stage (E), the verifier 104 inputs the LPN encryption of the input σ to a Boolean PRG G in NC⁰. By construction, instead of outputting the intended output G(σ) mod p, the PRG outputs

$$G ( {b}_{1} - 〈 {a}_{1} , s 〉 , … , {b}_{n} - 〈 n , s 〉 ) = G ( {e}_{1} + {σ}_{1} , … , n + {σ}_{n} ) = G ( σ + e ) mod p , \qquad ( 5 )$$

where {αⱼ}_{j∈[n]} ∈ [symbol] are column vectors that form the LPN public matrix A and bᵢ= [symbol] aᵢ, s [symbol] +eᵢ+σᵢ is an LPN instance, with eᵢ and σᵢ denoting the i-th indices of the LPN error vector e and the input σ, respectively. Since the output G(σ+e) mod p deviates from the intended output G(σ) mod p, the output G(σ+e) mod p is referred to as a first erroneous output.

During stage (F), the verifier 104 uses components of the secret seed to recover G(σ) mod p from the first erroneous output G(σ+e) mod p. For example, the verifier 104 can use known error correction techniques to recover G(σ) mod p from G(σ+e) mod p, e.g., techniques based on a correction vector with matrix factors that are equal to the components of the secret seed (where the secret seed does not leak the correction vector). Such techniques use the fact that LPN errors are sparse to factor the corresponding correction matrix and compress the factors. The LPN errors are randomly assigned in B buckets to spread the errors evenly with high probability (by Chernoff argument). The matrix form of each bucket is factored. Given the sparsity of the errors, the resulting matrices have fewer nonzero elements. A polynomial from the polynomial map is used to reconstruct the correction matrix such the final output is error corrected. The secrecy is maintained because polynomial Q⁽ⁱ⁺¹⁾ in the polynomial map is independent of the LPN errors in the polynomial Q⁽ⁱ⁾. In the unlikely case that any of the B buckets get more than the threshold number of errors that the error correction can handle, the evaluation returns 0. This is possible because the random assignment in the first step may lead to very uneven distribution of errors among the buckets.

During stage (G), the verifier 104 uses the trained regression model 114 to predict a response e′ generated by the obfuscator's PUF 112 on the initial component of the secret seed S₀. During stage (H), the verifier 104 updates the public seed using the predicted response as P=(A, sA+e+σ−e′) and evaluates the PRG on the updated public seed. By construction, as described above, instead of outputting the intended output G(σ) mod p, the PRG outputs G(e+σ−e′) mod p. This output is referred to as a second erroneous output.

During stage (I), the verifier 104 verifies the LPN encryption of the input σ in the public seed received from the obfuscator during stage (D). In particular, the verifier 104 confirms that the obfuscator 102 used its PUF 112 to generate the LPN error in the LPN encryption of the input σ. It is known that PRGs in NC⁰ have a locality of at least 4. Given this information and the assumption that on-average, the trained regression model 114 incurs 1% prediction errors, the number of bits that differ between the PRG outputs G(σ) mod p and G(σ+e−e′) mod p is

$$Δ = \frac{n - 4}{I 00 {n}^{γ}} = \frac{{l}^{c - 4}}{I 00 {l}^{c γ}}$$

for some constant c>1 and γ≈1−ε for some positive real ε that is close to zero. Recall that [symbol] =poly(λ), which means that [symbol] >4. Since [symbol] is typically over 250 for LPN, it can be concluded that the numerator is very close to [symbol] ^{c}. For efficient implementations, [symbol] should be close to the lower bound of ˜250, and for that, 100= [symbol] ^{ρ}, where ρ≈0.84. So, returning to the Hamming distance, the following is obtained:

$$\frac{{ℓ}^{c}}{{ℓ}^{c γ + \text{.84}}} = {ℓ}^{c - c γ - \text{.84}} = {ℓ}^{κ} for κ ∈ ( 0 , 1 ) .$$

Therefore, the Hamming distance, denoted by Δ, between the outputs G(σ) mod p and G(σ+e−e′) mod p is less than n (<<n) when the expectation for the Hamming weight of the PRG output is m/2>n/2 where

$$\frac{m}{2} = \frac{{n}^{ϱ}}{2}$$

and therefore

$$\frac{m}{2} = \frac{{ℓ}^{ϱ c}}{2}$$

for positive constants c, [symbol] >1.

Since G is a PRG in NC⁰, its pseudorandomness ensures that if this check passes, then the obfuscator must have used its PUF 112 to generate the error for the LPN encryption of the input σ.

Therefore, in the first verification process, the verifier 104 computes the Hamming distance between the corrected PRG output obtained during stage (F) and the second erroneous PRG output obtained during stage (H). The verifier determines whether the Hamming distance is less than n (the value of which was determined during the setup process). Since the expected Hamming weight is

$$\frac{m}{2} = \frac{{ℓ}^{ϱ c}}{2} ,$$

it is much greater than [symbol]
because ϰ is strictly smaller than 1 and QC is much greater than 1. Therefore, the verification must satisfy a condition that cannot be satisfied by a “normal” PRG output—i.e., where the intended PUF was not used. If the Hamming distance satisfies the condition, the verifier 104 verifies the behavior of the obfuscator 102, i.e., that the obfuscator 102 used its PUF 112 and the predetermined cryptographic parameters to generate the error for the LPN encryption of the input σ. Since the LPN encryption of the input σ is embedded within an obfuscated version of the circuit or program, this in turn enables the verifier 104 to validate the iO scheme used to obfuscate the circuit or program.

By verifying the obfuscator's behavior, the verifier 104 can perform a variety of actions for assisting in realizing goals of performing obfuscation, depending on the specific use case. For example, the verifier 104 can issue a digital certificate, cryptographically certifying the obfuscator's behavior. As another example, the verifier 104 can compute a cryptographic hash as: Hash (Obfuscator ID ∥Hash (obfuscated program)), digitally sign it and publish on a public blockchain. This adds a record of successful verification to the public ledger. As another example, the verifier 104 can release the obfuscated program for public use along with a certificate issued by the verifier 104. For instance, if the obfuscated program fixes critical security vulnerabilities in some popular software, then releasing it with a verifiable certificate would allow the public to patch the vulnerabilities in a trusted manner without leaking details on the vulnerabilities to the public—because the logic to fix the vulnerabilities is hidden by iO.

If the Hamming distance does not satisfy the condition, the verifier 104 does not verify the behavior of the obfuscator 102.

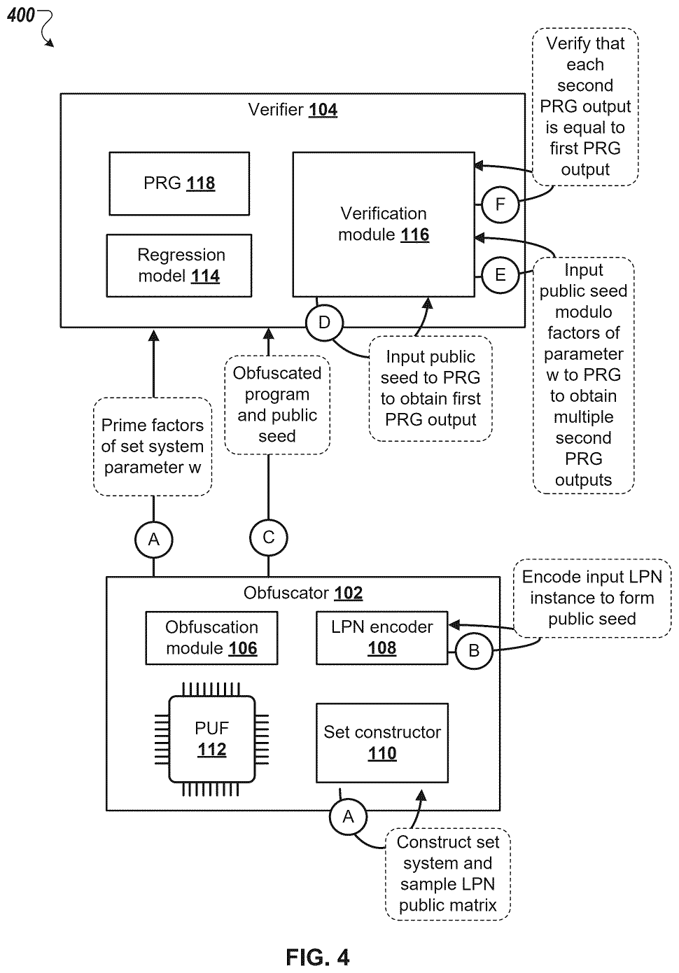

FIG. 4 is a block diagram 400 of the example cryptographic obfuscation verification 100 of FIG. 1 during a second example cryptographic obfuscation verification process. The block diagram 400 illustrates the second example cryptographic obfuscation verification process as including six stages (A)-(F). However, in some implementations the second example cryptographic obfuscation verification process can include fewer or more stages.

The second example cryptographic obfuscation verification process can be performed instead of or in conjunction with the first example cryptographic obfuscation verification process described above with reference to FIG. 3. In implementations where the second example cryptographic obfuscation verification process is performed instead of the first example cryptographic obfuscation verification process, the setup process described above with reference to FIG. 2 only requires stage (A), where cryptographic parameters for the obfuscation and verification are shared. However, in either case the obfuscator places an additional requirement on the input σ to the PRG, which is that the input is sampled from a ring of integers modulo a prime number that is equal to the minimum prime in the factorization of the parameter w and that the output length is equal to a product of the primes included in the factorization of the parameter w. That is

$$σ ∈ {ℤ}_{\overline{p}} where \overline{p} = min \{ {p}_{i} \} and m = {\sum }_{i = 1}^{r} {p}_{i} .$$

During stage (A) of the second example cryptographic obfuscation verification process, the obfuscator 102 uses the set constructor 110 to construct a set system and sample an LPN public matrix. Stage (A) of the second example cryptographic obfuscation verification process is similar to stage (A) of the first example cryptographic obfuscation verification process described with reference to FIG. 3, and for brevity details are not repeated.

During stage (B), the obfuscator 102 encrypts an input σ to the PRG in an LPN instance as As+e+σ, where A represents the LPN public matrix, s represents an LPN secret, and e represents a LPN error, and forms a public seed P=(A, As+e+σ) for the PRG. Stage (B) of the second example cryptographic obfuscation verification process is similar to stage (C) of the first example cryptographic obfuscation verification process described with reference to FIG. 3, except that the obfuscator 102 can use alternative methods to sample the LPN error.

During stage (E), the obfuscator 102 obfuscates a program using the PRG and the public seed P and sends the obfuscated program, the public seed P, and an initial component of the secret seed to the verifier 104. The PRG is included in the obfuscated program, e.g., as part of its codebase.

During stage (D), the verifier 104 inputs the LPN encryption of the input σ to the PRG. As discussed above with reference to stage (E) of the first example cryptographic obfuscation verification process, by construction, the PRG outputs a first erroneous output G(σ+e) mod p.

During stage (E), the verifier 104 identifies the factors of the parameter w and, for each factor, computes a modulo with respect to the factors of the public seed (the LPN encryption of the input). That is, the verifier 104 computes

$${P}_{i} = P mod {p}_{i}^{{α}_{i}} \qquad ( 6 )$$

where P represents the public seed,

$${p}_{i}^{{α}_{i}}$$

represents an i-th factor of the parameter

$$w = {\prod }_{i = 1}^{r} {p}_{i}^{{α}_{i}}$$

shared with the verifier 104 during stage (A), where pᵢ is a prime number and aᵢ is a positive integer. The verifier 104 then inputs each Pᵢ into the PRG to obtain a respective PRG output G(Pᵢ).

During stage (F), the verifier 104 verifies that each output G(Pᵢ) is equal to the first erroneous output G(σ+e). That is, the verifier 104 verifies that

$$∀ i ∈ [ r ] , G ( {P}_{i} ) = G ( σ + e ) . \qquad ( 7 )$$

This verification follows because, by construction,

$$P mod {p}_{i}^{{α}_{i}} = σ + e since sA = 0 mod {p}_{i}^{{α}_{i}} .$$

The verification verifies the behavior of the obfuscator 102, i.e., verifies that the obfuscator 102 generated the error for the LPN encryption of the input σ using a LPN public matrix A and LPN secret that were sampled from the intended set system and using the predetermined cryptographic parameters. Since the LPN encryption of the input σ is embedded within an obfuscated version of the circuit or program, this in turn enables the verifier 104 to validate the iO scheme used to obfuscate the circuit or program and perform a subsequent action, as described above.

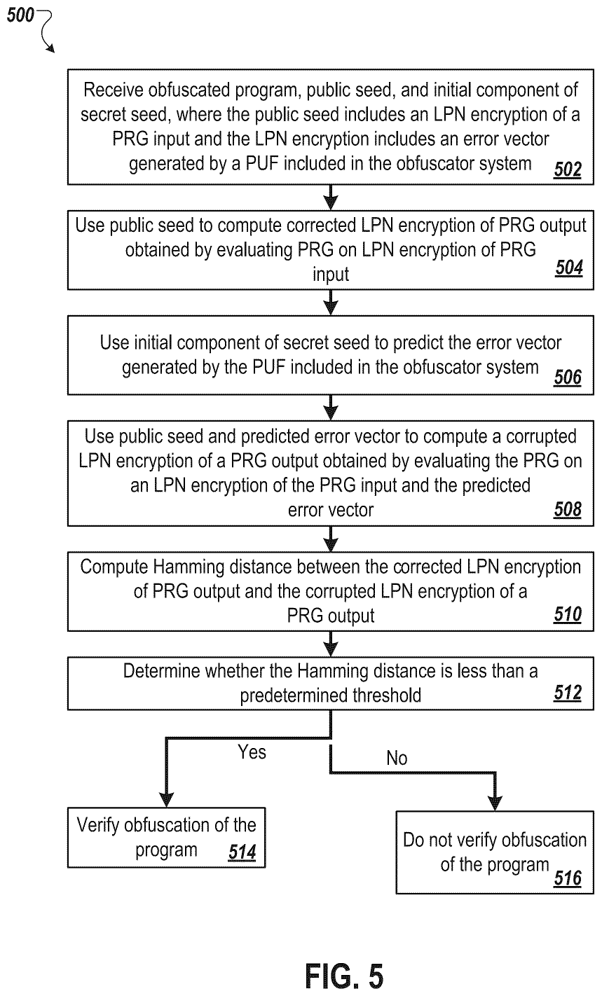

FIG. 5 is a flowchart of a first example process 500 performed by verifier system for verifying an obfuscation of a program. For convenience, example process 500 will be described as being performed by a verifier system using one or more computers located in one or more locations. For example, the verifier 104 of FIG. 1, appropriately programmed, can perform example process 500. Although the flowchart depicts the various stages of the process 500 occurring in a particular order, certain stages may in some implementations be performed in parallel or in a different order than what is depicted in the example process 500 of FIG. 5.

The verifier system receives an obfuscated program, a public seed and a secret seed from an obfuscator system (step 502). The obfuscated program is a program that has been obfuscated by the obfuscator system using the public seed, secret seed, and a PRG, e.g., a Boolean PRG in the complexity class NC⁰. The PRG is included in the obfuscated program, e.g., as part of its codebase.

The public seed is generated by the obfuscator system using a set system with a specific structure. In particular, the set system is constructed such that inner products of pairs of representative vectors of the set system are equal to zero, as described above with reference to Eqs. (1) and (2). Example operations performed by the obfuscator system to construct the set system and properties of the set system are described in detail with reference to FIGS. 1-4.

The public seed includes an LPN encryption of a PRG input that is embedded in the obfuscated program, e.g., the LPN encryption of the PRG input σ given by Eq. (4) above. The LPN encryption of the PRG input is generated by the obfuscator system using a public matrix A sampled from a subset of sets included in the set system, where the subset of sets contains supersets of a randomly selected subset in the set system and representative vectors of sets included in the subset of sets form columns of the public matrix. The obfuscator system generates the LPN encryption of the PRG input using a ring of integers modulo a prime number p that is less than or equal to a minimum prime number included in a factorization of a parameter w selected and used by the obfuscator system to construct the set system, where the representative vectors of the set system are sampled modulo the parameter w.

The LPN encryption of the PRG input also includes an LPN secret vector s. The LPN secret vector is a representative vector of the randomly selected subset used to generate the public matrix A. Further, the LPN encryption of the PRG input includes an error vector e generated by a PUF included in the obfuscator system.

The initial component of the secret seed is a degree

$$⌈ \frac{d}{2} ⌉$$

tensor of a vector that includes the LPN secret vector s used to generate the LPN encryption of the PRG input, where d represents a depth of the PRG circuit used to obfuscate the program. For example, the initial component of the secret seed can be given by Eq. (3) above.

The verifier system uses the public seed and the PRG to compute a “corrected” PRG output (step 504). That is, the verifier system computes G(σ) as described above with reference to FIG. 3. For example, the verifier system can evaluate the PRG on the LPN encryption of the PRG input σ to obtain a “corrupted” PRG output G(e+σ). The verifier system can then use components of the secret seed to recover the corrected PRG output G(σ) from the corrupted PRG output G(e+σ).

The verifier system uses the initial component of the secret seed to predict the error vector generated by the PUF included in the obfuscator system (step 506). For example, the verifier system can input the initial component of the secret seed into a regression model that has been trained to predict responses generated by the PUF included in the obfuscator system. The verifier system can train the regression model as part of a setup process performed prior to example process 500, as described above with reference to FIG. 2.

The verifier system updates the LPN encryption of the PRG input to include the predicted error vector, e.g., updates the LPN encryption as sA+e+σ→sA+e+σ−e′. The verifier system then computes a corrupted PRG output obtained by evaluating the PRG on the updated LPN encryption of the PRG input (step 508). That is, the verifier system computes G(e+σ−e′) as described above with reference to FIG. 3.

The verifier system then computes a Hamming distance between the corrected PRG output and the corrupted PRG output obtained by evaluating the PRG on the updated LPN encryption of the PRG input (step 510). That is, the verifier system computes the Hamming distance between G(σ) and G(e+σ−e′). As described above with reference to FIG. 3, since PRGs in NC⁰ have a locality of at least 4 and the trained regression model incurs a threshold amount of prediction errors, e.g., 1% prediction errors, the number of bits that differ between the corrected PRG output and the corrupted PRG output obtained by evaluating the PRG on the updated LPN encryption of the PRG input is bounded such that the Hamming distance between the corrected PRG output and the corrupted PRG output obtained by evaluating the PRG on the updated LPN encryption of the PRG input is less than a predetermined threshold (that is dependent on the length of the error vector) if the obfuscator uses its PUF to generate the error vector included in the public seed.

The verifier system determines whether the Hamming distance is less than the predetermined threshold (step 512). In response to determining that the Hamming distance is less than the predetermined threshold, the verifier system verifies the obfuscation of the program (step 514). That is, the verifier system verifies that the obfuscator system used its PUF (and correct values of pre-shared cryptographic parameters) to perform the obfuscation of the program (the program itself is not verifiers, since leaking information about the program is contrary to the definition of indistinguishability obfuscation). In response to determining that the Hamming distance is not less than the predetermined threshold, the verifier system does not verify the obfuscation of the program (step 516). For example, the verifier system can determine that the program has not been properly/appropriately obfuscated.

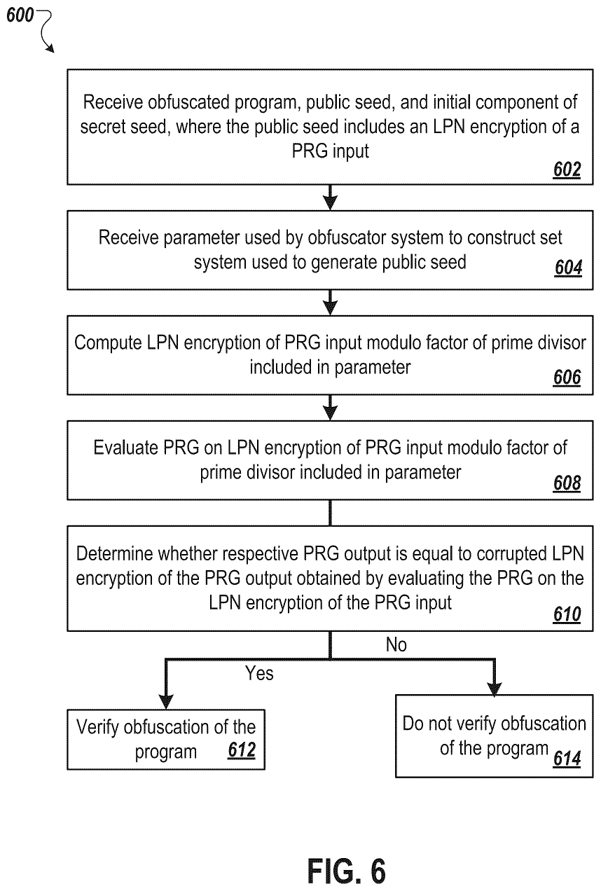

FIG. 6 is a flowchart of a second example process 600 performed by a verifier system for verifying an obfuscation of a program. For convenience, the process 600 will be described as being performed by a verifier system using one or more computers located in one or more locations. For example, the verifier 104 of FIG. 1, appropriately programmed, can perform example process 600. Although the flowchart depicts the various stages of the process 600 occurring in a particular order, certain stages may in some implementations be performed in parallel or in a different order than what is depicted in the example process 600 of FIG. 6.

The verifier system receives an obfuscated program and a public seed from an obfuscator system (step 602). As described above with reference to step 502 of example process 500 in FIG. 5, the obfuscated program is a program that has been obfuscated by the obfuscator system using the public seed, a secret seed, and a PRG, e.g., a Boolean PRG in the complexity class NC⁰. The PRG is included in the obfuscated program, e.g., as part of its codebase. The public seed includes a LPN encryption of a PRG input and is embedded in the obfuscated program. The public seed is generated by the obfuscator system using a set system with a specific structure, e.g., the set systems described with reference to FIGS. 1, 3-6. For brevity, details of the set system are not repeated.

The verifier system receives a parameter used by the obfuscator system to construct the set system (step 604). The parameter includes multiple prime divisors. The verifier system performs the following operations for each unique prime divisor included in the parameter. The verifier system computes the LPN encryption of the PRG input modulo a factor of the prime divisor included in the parameter (606). The verifier system evaluates the PRG on the computed LPN encryption of the PRG input modulo the factor of the prime divisor included in the parameter to obtain a respective PRG output (step 608). The verifier system determines whether the respective PRG output is equal to a corrupted PRG output obtained by evaluating the PRG on the LPN encryption of the PRG input (step 610). In response to determining that each respective PRG output is equal to the corrupted PRG output obtained by evaluating the PRG on the LPN encryption of the PRG input, the verifier system verifies the obfuscation of the program (step 612). Steps 604-612 correspond to stages (D)-(F) shown in FIG. 4, and for brevity, details are not repeated.

In some implementations, second example process 600 can be performed instead of first example process 500 of FIG. 5, e.g., in settings where the obfuscator does not include a PUF. In other implementations, second example process 600 can be performed in conjunction with example process 500. For example, steps 604-612 of second example process 600 can be performed after step 512 of example process 500. In these implementations, the verifier system can verify the obfuscation of the program when both verification processes pass.

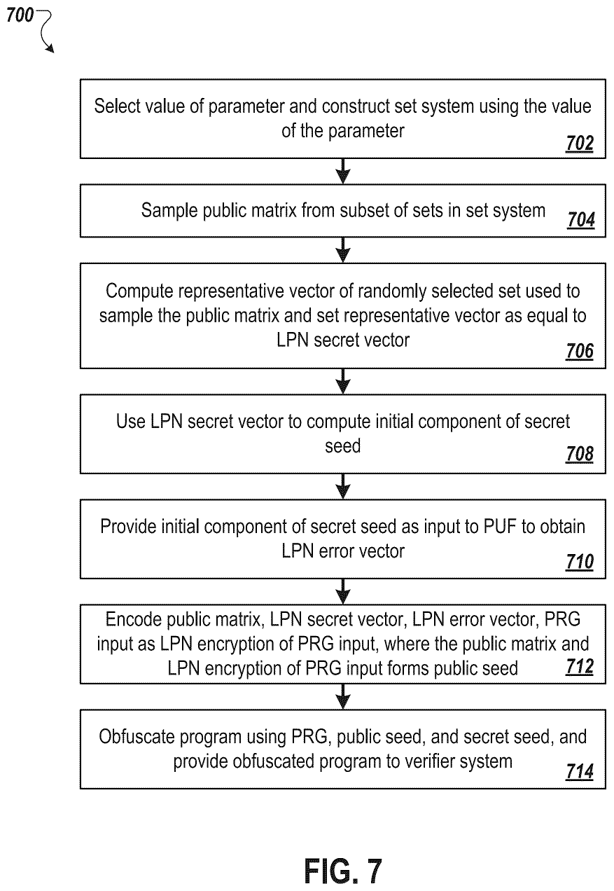

FIG. 7 is a flowchart of an example process 700 performed by an obfuscator system for obfuscating a program, e.g., the obfuscated program provided to the verifier system in first example process 500 of FIG. 5 or second example process 600 of FIG. 6. For convenience, the process 700 will be described as being performed by a obfuscator system using one or more computers located in one or more locations. For example, the obfuscator 102 of FIG. 1, appropriately programmed, can perform example process 700. Although the flowchart depicts the various stages of the process 700 occurring in a particular order, certain stages may in some implementations be performed in parallel or in a different order than what is depicted in the example process 700 of FIG. 7.

The obfuscator system selects a value of a parameter w and uses the parameter to construct a set system (step 702). The set system is constructed such that one or more of the following properties hold: a size of the set system is exponential in a predetermined security parameter λ. Each subset in the set system has a size that is equal to zero modulo the parameter w. Sizes of pairs of subsets included in the set system are equal or proportional. A size of an intersection of a first set included in the set system and a second set included in the set system is equal to zero modulo the parameter w if the first or second set is contained in the second or first set, respectively, else non-zero. The set system has t-wise restricted intersections modulo the parameter w. Each set in the set system is either a subset of a first constant number of sets included in the set system and not a superset of any set included in the set system, where the first constant number is equal to s^{l-1} with s a constant that satisfies

$$s \geq exp ( c \frac{{( log ℓ )}^{r}}{{( log log ℓ )}^{r - 1}} ) ,$$

r a number of unique prime divisors in the parameter w, [symbol] the LPN dimension, and I an integer that is less than a minimum prime divisor of the prime divisors, or is a superset of a second constant number of sets included in the set system and not a subset of any sets included in the set system, where the second constant number is equal to l. A size of an intersection of a first set included in the set system and a different second set included in the set system is equal to zero or one, modulo each prime (power) divisor included in the parameter w. The set system constructed at step 702 is described in more detail above with reference to FIGS. 1 and 3.

The obfuscator system samples a public matrix from a subset of sets included in the set system (step 704). The obfuscator system randomly selects a set H from the set system and identifies the supersets of the randomly selected set. The supersets form a subset of sets [symbol] _{H} included in the set system. The obfuscator system then samples a number of sets from the supersets. The obfuscator system uses representative vectors of the sampled sets to construct the public matrix, e.g., by setting each representative vector as a respective column of the public matrix.

The obfuscator system then computes a representative vector of the randomly selected set in the set system and sets the LPN secret vector as equal to the representative vector (step 706). The obfuscator system uses the LPN secret vector to compute an initial component of the secret seed (step 708). For example, the obfuscator system computes the tensor given by Eq. (3) above. The remaining components of the secret seed are can be derived from the (matrix) factors of the correction matrix. These factors are evaluated by a degree 2 polynomial for error correction.

The obfuscator system generates an error vector (step 710). In some implementations, e.g., when the obfuscator system and verifier system agree to use example process 500 of FIG. 5 as a verification process, the obfuscator system provides the initial component of the secret seed as input to its PUF to obtain an output that represents the error vector.

The obfuscator system then encodes the public matrix, LPN secret vector, error vector, and a PRG input as an LPN encryption of the PRG input (step 712). The public matrix and LPN encryption of the PRG input forms a public seed. The obfuscator system obfuscates a program using a PRG, the public seed, and the secret seed and provides the obfuscated program to the verifier system (step 714).

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1.-16. (canceled)

17. A classical computing system comprising one or more computers and one or more storage devices storing instructions that are operable, when executed by the one or more computers, to cause the one or more computers to perform operations comprising:
receiving, from an obfuscator system, an obfuscated program, a public seed and a secret seed, the public seed comprising a learning with parity (LPN) encryption of a PRG input that is embedded in the obfuscated program, wherein the LPN encryption of the PRG input is generated using an error vector generated by physically unclonable function (PUF) included in the obfuscator system;
computing, using the public seed, a corrected PRG output obtained by evaluating the PRG on the LPN encryption of the PRG input;
predicting, using an initial component of the secret seed, the error vector generated by the PUF included in the obfuscator system;
computing, using the public seed and the predicted error vector, a corrupted PRG output obtained by evaluating the PRG on an LPN encryption of the PRG input and the predicted error vector;
computing a Hamming distance between the corrected PRG output and the corrupted PRG output;
determining whether the Hamming distance is less than a predetermined threshold that is dependent on a length of the error vector; and
in response to determining that the Hamming distance is less than the predetermined threshold, verifying the obfuscation of the program.

18.-21. (canceled)

22. The classical computing system of claim 17, wherein the initial component of the secret seed comprises a tensor of a vector comprising an LPN secret vector used to generate the LPN encryption of the PRG input, wherein the tensor is of degree
$$⌈ \frac{d}{2} ⌉ ,$$
d representing a depth of the PRG circuit.

23. The classical computing system of claim 17, wherein predicting the error vector sampled from the PUF included in the obfuscator system comprises inputting the initial component of the secret seed into a regression model, wherein the regression model is trained to predict responses generated by the PUF included in the obfuscator system on unseen inputs.

24. The classical computing system of claim 23, wherein operations further comprise, prior to receiving the obfuscated program, public seed and secret seed:
training the regression model, comprising:
generating a set of random challenges;
sending the set of random challenges to the obfuscator system, wherein the obfuscator system runs the set of random challenges multiple times using the PUF to obtain multiple responses to each challenge in the set of random challenges;
receiving, from the obfuscator system, the multiple responses to each challenge in the set of random challenges; and
training the regression model on training data comprising the set of random challenges and multiple responses to predict responses generated by the obfuscator PUF on an unseen input challenge.

25. The classical computing system of claim 24, wherein operations further comprise receiving, from the obfuscator system, a parameter used by the obfuscator system to construct the set system, and wherein the method further comprises using the parameter to verify that the LPN encryption of the PRG input was sampled from the set system.

26. The classical computing system of claim 17, wherein the public seed is generated by the obfuscator system using a set system constructed by the obfuscator system, wherein inner products of pairs of representative vectors of the set system are equal to zero.

27. The classical computing system of claim 26, wherein the LPN encryption of the PRG input is generated using a ring of integers modulo a prime number that is less than or equal to a minimum prime number included in a factorization of a parameter selected and used by the obfuscator system to construct the set system, wherein the representative vectors of the set system are sampled modulo the parameter.

28. The classical computing system of claim 26, wherein the LPN encryption of the PRG input further comprises a public matrix sampled from a subset of sets included in the set system, wherein the subset of sets contains supersets of a randomly selected set in the set system, wherein a plurality of representative vectors of sets included in the subset of sets form columns of the public matrix.

29. The classical computing system of claim 28, wherein the LPN encryption of the PRG input further comprises a LPN secret vector that is equal to a representative vector of the randomly selected set in the set system.

30. The classical computing system of claim 28, wherein operations further comprise:
selecting, by the obfuscator system, a value of a parameter and using the parameter to construct, by the obfuscator system, the set system;
sampling, by the obfuscator system, the public matrix from the subset of sets included in the set system;
computing, by the obfuscator system, the representative vector of the randomly selected set in the set system and setting an LPN secret vector as equal to the representative vector;
computing, by the obfuscator system and using the LPN secret vector, the initial component of the secret seed;
providing, by the obfuscator system, the secret seed as input to the PUF to obtain an output that represents the error vector; and
encoding, by the obfuscator system, the public matrix, LPN secret vector, error vector, and PRG input as the LPN encryption of the PRG input.

31. The classical computing system of claim 26, wherein one or more of:
a size of the set system is exponential in a predetermined security parameter;
each set in the set system has a size that is equal to zero modulo a parameter that comprises multiple different prime divisors;
sizes of pairs of sets included in the set system are equal or proportional;
a size of an intersection of a first set included in the set system and a second set included in the set system is equal to zero modulo the parameter that comprises multiple different prime divisors if the first or second set is contained in the second or first set, respectively, else non-zero;
the set system has t-wise restricted intersections modulo the parameter that comprises multiple different prime divisors;
each set in the set system is either a subset of a first constant number of sets included in the set system and not a superset of any set included in the set system or is a superset of a second constant number of sets included in the set system and not a subset of any sets included in the set system; or
a size of an intersection of a first set included in the set system and a different second set included in the set system is equal to zero or one, modulo each prime power divisor included in the parameter.

32. The classical computing system of claim 31, wherein the first constant number is equal to s^{l-1}, where s is a constant that satisfies
$$s \geq exp ( c \frac{{( log ℓ )}^{r}}{{( log log ℓ )}^{r - 1}} ) ,$$
r is a number of unique prime divisors in the multiple prime divisors, [symbol] represents LPN dimension, and l is an integer that is less than a minimum prime divisor of the multiple prime divisors, and the second constant number is equal to l.

33. The classical computing system of claim 30, wherein verifying that the LPN encryption of the PRG input was sampled from the set system comprises:
for each unique prime divisor included in the parameter:
computing the LPN encryption of the PRG input modulo a prime divisor included in the parameter;
evaluating the PRG on the computed LPN encryption of the PRG input modulo the prime divisor included in the parameter to obtain a respective PRG output; and
determining whether the respective PRG output is equal to a second corrupted PRG output obtained by evaluating the PRG on the LPN encryption of the PRG input; and
in response to determining that each respective PRG output is equal to the second corrupted PRG output obtained by evaluating the PRG on the LPN encryption of the PRG input, verifying the obfuscation of the program.

34. The classical computing system of claim 17, wherein the PRG comprises a Boolean PRG in complexity class NC⁰.

35. The classical computing system of claim 17, wherein operations further comprise, prior to receiving the obfuscated program, public seed and the secret seed, sharing, with the obfuscator system, values of cryptographic parameters for the obfuscation of the program.

36. The classical computing system of claim 17, wherein computing the corrected PRG output obtained by evaluating the PRG on the LPN encryption of the PRG input comprises using components of the secret seed to recover the output obtained by evaluating the PRG on the PRG input.

37. A computer-readable storage medium comprising instructions stored thereon that are executable by a classical processing device and upon such execution cause the processing device to perform operations comprising:
receiving, from an obfuscator system, an obfuscated program, a public seed and a secret seed, the public seed comprising a learning with parity (LPN) encryption of a PRG input that is embedded in the obfuscated program, wherein the LPN encryption of the PRG input is generated using an error vector generated by physically unclonable function (PUF) included in the obfuscator system;
computing, using the public seed, a corrected PRG output obtained by evaluating the PRG on the LPN encryption of the PRG input;
predicting, using an initial component of the secret seed, the error vector generated by the PUF included in the obfuscator system;
computing, using the public seed and the predicted error vector, a corrupted PRG output obtained by evaluating the PRG on an LPN encryption of the PRG input and the predicted error vector;
computing a Hamming distance between the corrected PRG output and the corrupted PRG output;
determining whether the Hamming distance is less than a predetermined threshold that is dependent on a length of the error vector; and
in response to determining that the Hamming distance is less than the predetermined threshold, verifying the obfuscation of the program.

38. The computer-readable storage medium of claim 37, wherein the initial component of the secret seed comprises a tensor of a vector comprising an LPN secret vector used to generate the LPN encryption of the PRG input, wherein the tensor is of degree
$$⌈ \frac{d}{2} ⌉ ,$$
d representing a depth of the PRG circuit.

39. The computer-readable storage medium of claim 37, wherein predicting the error vector sampled from the PUF included in the obfuscator system comprises inputting the initial component of the secret seed into a regression model, wherein the regression model is trained to predict responses generated by the PUF included in the obfuscator system on unseen inputs.

40. The computer-readable storage medium of claim 39, wherein operations further comprise, prior to receiving the obfuscated program, public seed and secret seed:
training the regression model, comprising:
generating a set of random challenges;
sending the set of random challenges to the obfuscator system, wherein the obfuscator system runs the set of random challenges multiple times using the PUF to obtain multiple responses to each challenge in the set of random challenges;
receiving, from the obfuscator system, the multiple responses to each challenge in the set of random challenges; and
training the regression model on training data comprising the set of random challenges and multiple responses to predict responses generated by the obfuscator PUF on an unseen input challenge.
